(19) United States
(12) Patent Application Publication
(10) Pub. No.: US 2011/0064888 A1
(43) Pub. Date: Mar. 17, 2011

(54) Portable heating apparatus for powder coating

(76) Inventor: Jeffery G. Whitley, Belleville (CA)

(21) Appl. No.: 12/585,356

(22) Filed: Sep. 11, 2009

(51) Int. Cl. B05D 3/02; B05C 9/14

(52) U.S. Cl. 427/542; 118/58; 118/641

(57) ABSTRACT

The present invention provides a portable apparatus for heating a surface of an object during powder coating. The object is fixed at a location, and a powder comprising a thermal plastic polymer or a thermoset polymer is applied to the surface of the object prior to heating. The apparatus comprises a portable support member, and a portable first heater for heating the surface of the object, the first heater being mounted to the support member.

### SCOPE OF THE INVENTION

The present invention relates to a heating apparatus for powder coating, and in particular, to a portable heating apparatus for powder coating bathtubs.

### BACKGROUND OF THE INVENTION

Powder coating is a painting process by which a thermoplastic polymer or thermoset polymer in the form of a dry powder is applied to an object. The powder is generally applied by an electrostatic gun and the object to be painted is generally electrically grounded. The electrostatic gun imparts a positive electric charge on the powder. The powder is sprayed towards the grounded object by mechanical or compressed air spraying, and then accelerated toward the object by the powerful electrostatic charge. The object is then transported to and placed into an oven where it is heated to a high temperature of about 160 to 210° C. for at least 10 minutes to cure the applied powder. Specifically, the powder particles melt and coalesce to form a continuous film. In the case of using thermoset polymers as the powder, when heated, a chemical cross-linking reaction is triggered between the polymers, thus increasing the molecular weight of the solid coating and giving a hard abrasion resistant coating.

Powder coating has several advantages over traditional liquid paints, including the fact that powder coatings emit much less volatile organic compounds. Furthermore, powder coatings can produce much thicker coatings than conventional liquid coatings without running or sagging.

One disadvantage of known powder coating processes is that the curing step must take place in an oven. As such, the object to be painted must be transported to the site of the curing oven. Many objects which are suitable for powder coating are fixed at one location and are not easily portable. Many objects which are suitable for powder coating can also be very difficult to transport because of their size, shape or weight. For example, bathtubs are generally fixed in a bathroom of a building and are difficult to transport because of their large size and weight and their shape. Obstructions which are common in many homes and businesses, such as narrow doorways, make it costly and inconvenient to transport bathtubs out of the home or business and to the site of the curing oven. It would be advantageous to be able to carry out the entire powder coating process, including the curing step, without having to transport the bathtub away from the home or business.

### SUMMARY OF THE INVENTION

To at least partially overcome the problems associated with powder coating, the present invention provides a portable heating apparatus for use in powder coating.

An object of the present invention is to provide a new portable heating apparatus for use in powder coating.

Another object of the present invention is to provide a heating apparatus for use in powder coating which is portable from one site to another.

A further object of the present invention is to provide a portable heating apparatus for powder coating objects without having to transport such objects to a curing oven.

A further object of the present invention is to provide a portable heating apparatus for use in powder coating which shields areas surrounding the object to be powder coated, thus preventing damage to these surrounding areas by the curing step.

Yet another object of the present invention is to provide a portable heating apparatus for use in powder coating which can be used with bathtubs of many different sizes and shapes.

In one aspect, the present invention provides portable apparatus for heating a surface of an object during powder coating, the object being fixed at a location, and wherein a powder comprising a thermal plastic polymer or a thermoset polymer is applied to the surface of the object prior to heating, the apparatus comprising: a portable support member, and a portable first heater for heating the surface of the object, the first heater being mounted to the support member.

The object being powder coated is preferably fixed in a room of a building. Preferably, the object is a bathtub. The bathtub may be fixed in a bathroom of a residential building or a hotel.

Preferably, the first heater is an infrared heater or a convection heater. When the first heater is an infrared heater, the infrared heater can have wires or filaments or radiant emmitters which are heated, and the wires or filaments emit heat by infrared radiation to the bathtub. When the first heater is a convection heater, the convection heater can have a heating element, where an air steam passes over the heating element to heat the air stream, and the heated air stream then passes to the bathtub.

The support member preferably has a first end and a second end. The first heater may be movable from a first position between the first end and the second end of the support member to a second position between the first end and the second end of the support member. Preferably, the first heater is mounted to the support member by one or more fasteners, such as one or more clamps. The one or more fasteners are attachable to the support member at multiple positions between the first end of the support member and the second end of the support member. The first heater is movable by moving the one or more fasteners from the first position on the support member to the second position on the support member.

The support member is preferably a vertical support member, with the first end of the support member being a top end, and the second end of the support member being a bottom end. The first heater is movable in the vertical direction between the top end and the bottom end.

In a preferred embodiment, the apparatus further comprises a portable horizontal support member. The horizontal support member has a third end and a fourth end, and is mounted at the third end to the vertical support member. The apparatus also preferably comprises a portable second heater for heating the surface of the object. The second heater is mounted to the horizontal support member.

The second heater is preferably an infrared heater or a convection heater.

The first heater mounted to the vertical support member preferably emits heat to an outside wall of the bathtub, while the second heater mounted to the horizontal support member preferably emits heat to an inside wall of the bathtub.

In a preferred embodiment, the apparatus further comprises a portable third heater for heating the surface of the object. The third heater is pivotally connected to the second heater by a connecting hinge. The connecting hinge is positioned above the inside wall of the bathtub. The second heater and the third heater can be pivoted towards or away from each other about the connecting hinge, thus allowing a user to direct both the second heater and the third heater in multiple directions. Preferably, the second heater and the third heater are directed towards two different areas of the inside wall of the bathtub. More preferably, the connecting hinge can be positioned inside the bathtub to facilitate directing the second heater and the third heater towards substantially opposed surfaces of the inside wall of the bathtub.

The third heater is preferably an infrared heater or a convection heater. Like the second heater, the third heater also emits heat to the inside wall of the bathtub.

Preferably, the apparatus further comprises a portable support arm extending from the third heater and contacting a vertical surface proximal to the bathtub. For example, the arm may contact a corner between the outer edge of the bathtub and an adjacent wall to act as a support for the apparatus.

The apparatus preferably comprises a portable shielding member for shielding an area surrounding the bathtub from the heat emitted by the first heater, the second heater and the third heater. For example, the shielding member may protect the bathroom walls and floors from heat damage.

The first heater is preferably movable up and down in the vertical direction. In other words, the vertical height of the first heater is adjustable so that it can heat bathtubs of different heights.

Preferably, the first heater is mounted to the vertical support member by one or more fasteners, such as a clamp. The fasteners can be attached to multiple vertical positions on the vertical support member. Therefore, for example, when the fastener is moved from a first lower vertical position on the vertical support member to a second higher vertical position on the vertical support member, the first heater, which is mounted by the fastener, is also moved upwards in the vertical direction.

The second heater and the third heater are preferably movable in the horizontal direction. Therefore, the position of the second heater and the third heater can be adjusted along the width of the bathtub.

The apparatus preferably comprises a portable inner bar section having a first end extending in the horizontal direction and a second end extending downwardly in the vertical direction. The inner bar section is mounted at the second end to the vertical support member. The horizontal support member preferably has a first outer bar section which extends in the horizontal direction and which is telescopically and slidably connected over the first end of the inner bar section. The first outer bar section has a larger diameter than the inner bar section. By sliding of the first outer bar section relative to the inner bar section, the second heater and the third heater, which are mounted to the horizontal support member, are movable in the horizontal direction.

The second heater and the third heater are preferably movable in the vertical direction. As such, the vertical height of the second heater and the third heater can be adjusted to accommodate bathtubs of different heights.

Preferably, the vertical support member has a second outer bar section which extends upwardly in the vertical direction and which is telescopically and slidably connected over the second end of the inner bar section. The second outer bar section has a larger diameter than the inner bar section. By sliding of the inner bar section relative to the second outer bar section, the second heater and the third heater, which are mounted to the horizontal support member, are movable in the vertical direction.

In another aspect, the present invention provides a method of powder coating a bathtub comprising the steps of: applying a powder comprising a thermal plastic polymer or a thermoset polymer to a surface of the bathtub, heating the surface of the bathtub with a portable heating apparatus, and allowing the thermoplastic polymer or thermoset polymer powder to cure.

Preferably, the portable heating apparatus used in this method of powder coating is the apparatus as defined above.

### BRIEF DESCRIPTION OF THE DRAWINGS

Further aspects and advantages will become apparent from the following description taken together with the accompanying drawings in which:

FIG. 1 is a perspective view of an apparatus in accordance with a preferred embodiment of the present invention.

FIG. 2 is a side view of the apparatus shown in FIG. 1.

FIG. 3 is a perspective view of a heater of the apparatus of FIG. 1 with the cover lifted off.

FIG. 4 is a perspective view of one side of the heater of the apparatus of FIG. 1.

FIG. 5 is an exploded view of the vertical support member and the horizontal support member of the apparatus of FIG. 1.

Throughout all the drawings and the disclosure, similar parts are indicated by the same reference numerals.

### DESCRIPTION OF THE PREFERRED EMBODIMENT

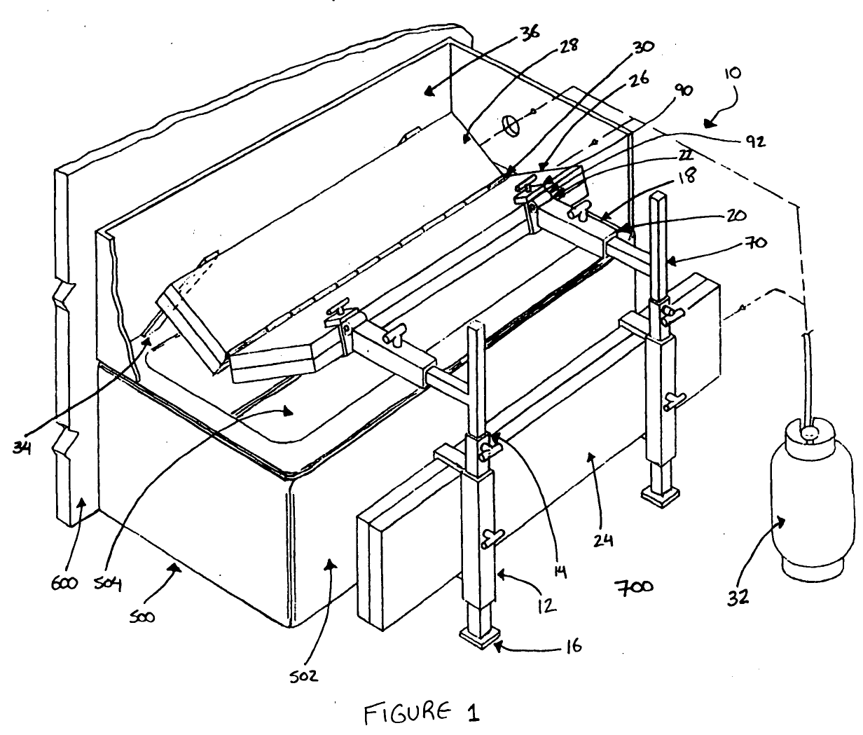

Reference is made to FIGS. 1 to 5 which show a preferred embodiment of the present invention.

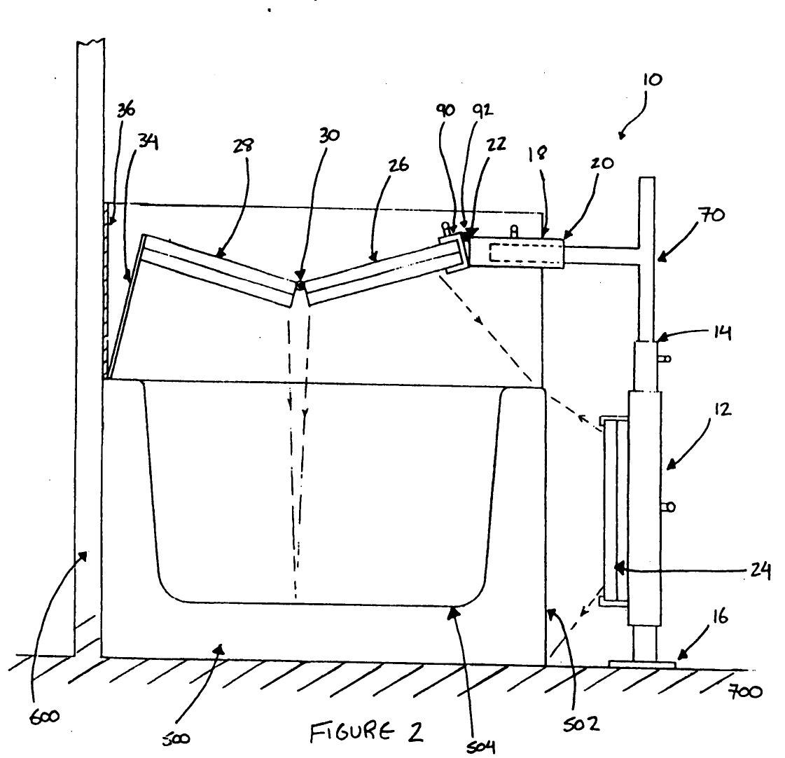

FIGS. 1 and 2 illustrate an apparatus in accordance with a preferred embodiment of the present invention. The apparatus 10 is used for the curing step when powder coating a conventional bathtub 500.

The apparatus 10 comprises a pair of vertical support members 12 having a first top end 14 and a second bottom end 16. The bottom end 16, as shown in FIG. 1, is enlarged and rests on the floor 700 adjacent to the bathtub 500.

The apparatus 10 also comprises a pair of horizontal support members 18 having a third end 20 and a fourth end 22. The horizontal support members 18 are mounted at the third end 20 to the vertical support members 12.

In an alternative embodiment, the apparatus 10 comprises a single vertical support member 12 and a single horizontal support member 18. In yet another alternative embodiment, the apparatus 10 comprises a single support member.

The vertical support members 12 and the horizontal support members 18 are preferably made of metal, more preferably steel.

A first heater 24 is mounted to the pair of vertical support members 12. Preferably, the first heater 24 is mounted to the pair of vertical support members 12 by clamps 60, as shown in FIG. 5.

A second heater 26 is mounted to the pair of horizontal support members 18. Preferably, the second heater 26 is mounted to the pair of horizontal support members 18 by clamps 90. The clamps 90 are pivotally connected to the horizontal support members 18 by hinges 92. The second heater 26 can be pivoted about hinges 92 so as to allow a user to point the second heater 26 in different directions.

A third heater 28 is pivotally connected to the second heater 26 by a connecting hinge 30.

Preferably, the first heater 24, second heater 26 and third heater 28 are infrared heaters. In an alternative embodiment, the first heater 24, second heater 26 and third heater 28 are convection heaters.

The heating element of the first heater 24 is present on one side of the first heater 24, and faces an outside wall 502 of the bathtub 500. As such, the first heater 24 emits heat to the outside wall 502 of the bathtub 500.

The heating elements of the second heater 26 and the third heater 28 are present on one side of the second heater 26 and the third heater 28, respectively. The heating elements of the second heater 26 and the third heater 28 are positioned so as to face downwards at an inside wall 504 of the bathtub 500. As such, the second heater 26 and the third heater 28 emit heat to the inside wall 504 of the bathtub 500.

The second heater 26 and the third heater 28 are pivotally connected to each other by the connecting hinge 30. The second heater 26 and the third heater 28 can be pivoted towards or away from each other about the connecting hinge 30. This allows a user to point both the second heater 26 and the third heater 28 in multiple directions. For a bathtub 500 with a larger width, the user can pivot the second heater 26 and the third heater 28 away from each other about the connecting hinge 30 so as to be able to emit heat to a larger surface area of the inside wall 504 of the bathtub 500.

A support arm 34 preferably extends from the third heater 28 and contacts a vertical surface proximal to the bathtub 500. In FIGS. 1 and 2, the support arm 34 extends from the third heater 28 and rests in the corner between an outer edge of the bathtub 500 and an adjacent wall 600. The support arm 34 acts as a support for the apparatus 10. The support arm 34 is preferably made of metal, more preferably steel.

A shielding member 36 is used to shield the area surrounding the bathtub 500 from the heat emitted from the first heater 24, the second heater 26 and the third heater 28. The shielding member 36 in FIGS. 1 and 2 rests on the outer edge of the bathtub 500 and protects the wall 600 and the bathroom floors 700 from heat damage.

The shielding member 36 can be made of any heat-resistant material. Examples include, but are not limited to, fire retardant materials such as gypsum, perlite, rock wool, asbestos cement and calcium silicate.

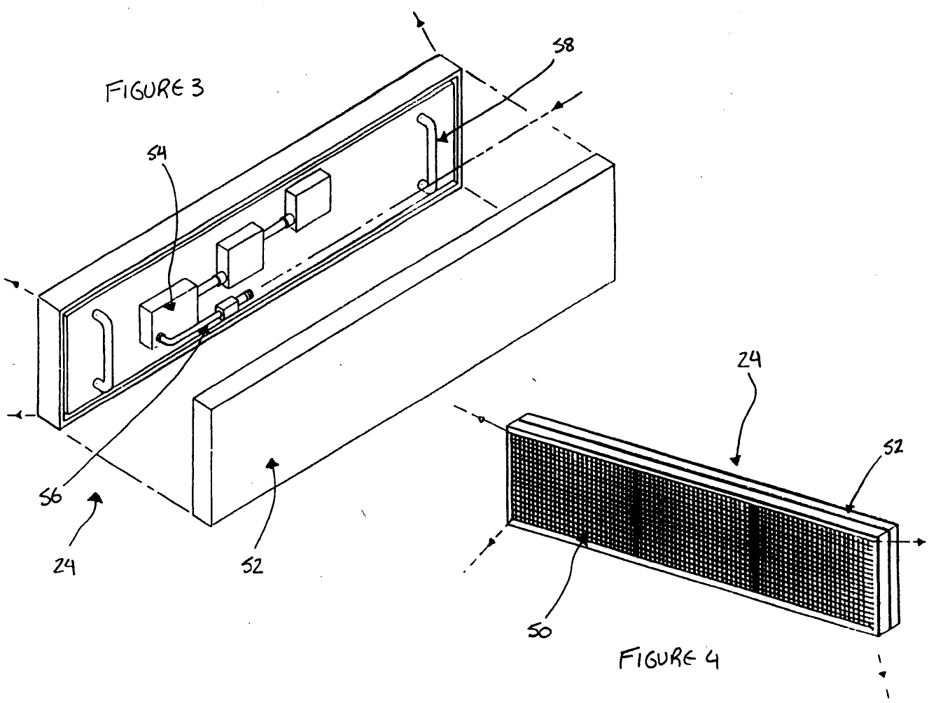

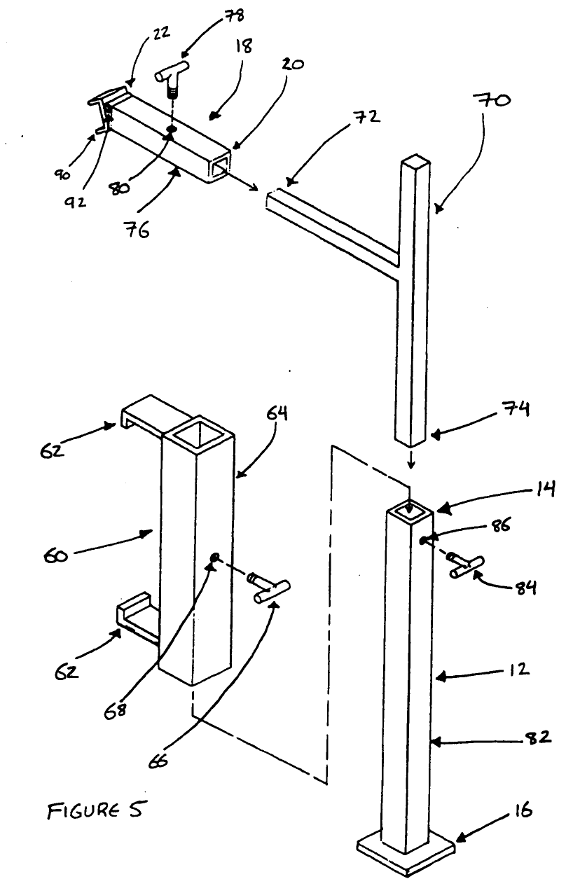

FIGS. 3 and 4 illustrate the first heater 24 in detail. The first heater 24, the second heater 26 and the third heater 28 preferably have the same construction. The heating element 50 of the first heater 24 is present on one side of the first heater 24. On the other side of the first heater 24 is a cover 52.

In the case where the first heater 24, second heater 26 and third heater 28 are infrared heaters, the heating element 50 is preferably a grid of wires or filaments. The wires or filaments can be made of any material that is commonly used for infrared heaters, including tungsten, carbon, and alloys of iron, chromium and aluminum. Optionally, the wires or filaments can be protected by a heat-resistant quartz glass shield. Optionally, a gold coating on the quartz glass shield can be used to reflect the infrared radiation and direct it towards the object to be heated.

The heating element 50 is present on one side of the first heater 24, second heater 26 and third heater 28. The grid of wires or filaments of the heating element 50 is heated, and then emits this heat by infrared radiation to the bathtub 500.

In the case where the first heater 24, second heater 26 and third heater 28 are convection heaters, the heating elements can be any material that is commonly used for convection heaters. For example, Nichrome 80/20 wire, ribbon or strip, composed of 80% nickel and 20% chromium, can be used as the heating element material. Other materials that can be used as the heating element material include Kanthal (FeCrAl) wires and Cupronickel (CuNi) alloys. A fan or air compressor can be used to pass an air stream over the heating element to heat up the air stream. The fan or air compressor then moves the heated air stream to the bathtub 500.

In the preferred embodiment, a propane tank 32 provides gas energy to the first heater 24, second heater 26 and third heater 28 to heat the grid of wires or filaments 50.

When the cover 52 is lifted off of the first heater 24, the combustion chamber 54 of the first heater 24 is exposed, as shown in FIG. 3. The combustion chamber 54 of the first heater 24 receives propane gas from the propane tank 32 through a pipe 56. A spark plug or ignition device or catalytic reaction in the combustion chamber 54 lights the propane gas mixed with air in the combustion chamber 54. This combustion reaction in the combustion chamber 54 produces heat for heating the heating element 50. In turn, the heating element 50 emits heat by infrared radiation to the bathtub 500.

An alternative embodiment to using gas is to use electricity. The first heater 24, second heater 26 and third heater 28 convert electricity into heat. Specifically, an electric current is sent to the heating element 50 and encounters resistance, thus resulting in the heating of the heating element 50.

Handles 58 are present on the first heater 24 for lifting the first heater 24 and transporting it.

FIG. 5 illustrates the vertical support member 12 and the horizontal support member 18 in detail.

The first heater 24 is preferably movable up and down in the vertical direction. Specifically, the vertical height of the first heater 24 is adjustable to accommodate bathtubs 500 of different heights.

The second heater 26 and the third heater 28 are preferably movable in both the horizontal direction and in the vertical direction. In other words, the position of the second heater 26 and third heater 28 can be adjusted along the width of the bathtub 500. Furthermore, the vertical height of the second heater 26 and the third heater 28 can be adjusted to accommodate bathtubs 500 of different heights.

As mentioned above, the vertical support member 12 has a first top end 14 and a second bottom end 16. The bottom end 16 is enlarged and rests on the floor 700.

A clamp 60 has a pair of hook elements 62 which are designed to hold the first heater 24. The clamp 60 comprises a hollow tube 64 which is telescopically and slideably connected over the vertical support member 12. Specifically, the hollow tube 64 of the clamp 60 has a larger diameter than the vertical support member 12, thus allowing the clamp 60 to slide up and down relative to the vertical support member 12. A threaded screw 66 fits into an opening 68 in the hollow tube 64 of the clamp 60.

When the clamp 60 is adjusted to the desired height on the vertical support member 12, the user inserts the screw 66 into the opening 68 of the clamp 60. The screw 66 frictionally engages the vertical support member 12, thus securing the vertical position of the clamp 60 on the vertical support member 12.

By sliding the hollow tube 64 of the clamp 60 up and down on the vertical support member 12, the first heater 24, which is held by the clamp 60, is also moved upwards and downwards in the vertical direction.

The apparatus 10 preferably comprises an inner bar section 70. The inner bar section 70 is preferably made of metal, more preferably steel. The inner bar section 70 has a first end 72 which extends in the horizontal direction and a second end 74 which extends downwards in the vertical direction. The inner bar section 70 is mounted at the second end 74 to the vertical support member 12.

The horizontal support member 18 has a first outer bar section 76 which extends in the horizontal direction. The first outer bar section 76 of the horizontal support member 18 is telescopically and slideably connected over the first end 72 of the inner bar section 70. The first outer bar section 76 has a larger diameter than the inner bar section 70. By sliding the first outer bar section 76 of the horizontal support member 18 relative to the inner bar section 70, the second heater 26 and the third heater 28, which are both mounted to the horizontal support member 18, are movable in the horizontal direction.

In use, the user slides the first outer bar section 76 of the horizontal support member 18 relative to the inner bar section 70 until the second heater 26 and the third heater 28 have reached a desired horizontal position. A threaded screw 78 is inserted into an opening 80 in the first outer bar section 76 and frictionally engages the first end 72 of the inner bar section 70 so as to secure this horizontal position.

The vertical support member 12 has a second outer bar section 82 which extends upwardly in the vertical direction. The second outer bar section 82 is telescopically and slideably connected over the second end 74 of the inner bar section 70. The second outer bar section 82 has a larger diameter than the inner bar section 70. By sliding of the inner bar section 70 relative to the second outer bar section 82, the second heater 26 and the third heater 28, which are mounted to the horizontal support member 18, are movable in the vertical direction.

In use, the user slides the second end 74 of the inner bar section 70 relative to the second outer bar section 82 of the vertical support member 12 until a desired height for the second heater 26 and the third heater 18 are reached. A threaded screw 84 is inserted through an opening 86 in the second outer bar section 82. The threaded screw 84 frictionally engages the second end 74 of the inner bar section 70, thus securing this vertical position.

To powder coat the bathtub 500, a powder comprising a thermal plastic polymer or a thermal set polymer is applied to the walls 502, 504 of the bathtub 500. Preferably, the powder is applied to the surface of the bathtub 500 by an electrostatic gun. The electrostatic gun imparts a positive electric charge on the powder, and the powder is sprayed towards the surface of the bathtub 500 by mechanical or compressed air spraying and then accelerated toward the bathtub by the powerful electric charge. The powder can be applied to both the outside wall 502 and the inside wall 504 of the bathtub 500. The apparatus 10 of the present invention is used to heat the outside wall 502 and the inside wall 504 of the bathtub 500 to cure the applied powder.

The apparatus 10 of the present invention is portable. As such, for powder coating objects such as a bathtub 500, there is no need to remove the bathtub 500 from the home or business, and transport the bathtub 500 to a curing oven. Instead, the portable apparatus 10 of the present invention is brought directly to the site of the bathtub 500 to be powder coated.

The apparatus 10 of the present invention is portable from one site to another and therefore, can be transported between homes and businesses to powder coat many different objects at many different locations.

The apparatus 10 of the present invention can be used with bathtubs 500 of many different sizes and shapes. Specifically, the vertical height of the first heater 24 can be adjusted to accommodate bathtubs 500 of many different heights. Both the vertical height and horizontal position of the second heater 26 and the third heater 28 can be adjusted. Further, the second heater 26 and the third heater 28 can be pivoted towards or away from each other so as to accommodate bathtubs 500 of many different widths.

The shielding member 36 protects the areas surrounding the bathtub 500, such as the wall 600 and the bathroom floors 700, from heat damage. This allows the apparatus 10 of the present invention to be used in homes and businesses without causing damage to areas surrounding the object to be powder coated.

Although this disclosure has described and illustrated preferred embodiments of the invention, it is to be understood that the invention is not restricted to these particular embodiments. Rather, the invention includes all embodiments that are functional or mechanical equivalents of the specific embodiments and features that have been described and illustrated herein. Many modifications will now occur to those skilled in the art. For a definition of the invention, reference is made to the following claims.

We claim:

1. A portable apparatus for heating a surface of an object during powder coating, the object being fixed at a location, and wherein a powder comprising a thermal plastic polymer or a thermoset polymer is applied to the surface of the object prior to heating,
the apparatus comprising:
a portable support member, and
a portable first heater for heating the surface of the object, the first heater being mounted to the support member.

2. The apparatus of claim 1, wherein the first heater is selected from the group consisting of an infrared heater and a convection heater.

3. The apparatus of claim 2, wherein the object is fixed in a room of a building.

4. The apparatus of claim 3, wherein the object is a bathtub.

5. The apparatus of claim 4, wherein the support member has a first end and a second end, and
the first heater is movable from a first position between the first end and the second end of the support member to a second position between the first end and the second end of the support member.

6. The apparatus of claim 5, wherein the first heater is mounted to the support member by one or more fasteners, said one or more fasteners being attachable to the support member at multiple positions between the first end of the support member and the second end of the support member,
wherein the first heater is movable by moving the one or more fasteners from the first position on the support member to the second position on the support member.

7. The apparatus of claim 6, wherein the support member is a vertical support member,
the first end of the support member being a top end, and the second end of the support member being a bottom end,
wherein the first heater is movable in the vertical direction between the top end and the bottom end.

8. The apparatus of claim 7, wherein the apparatus further comprises:
a portable horizontal support member, the horizontal support member having a third end and a fourth end, the horizontal support member being mounted at the third end to the vertical support member, and
a portable second heater for heating the surface of the object, the second heater being mounted to the horizontal support member.

9. The apparatus of claim 8, wherein the second heater is selected from the group consisting of an infrared heater and a convection heater.

10. The apparatus of claim 9, wherein the first heater emits heat to the surface of an outside wall of the bathtub, and the second heater emits heat to the surface of an inside wall of the bathtub.

11. The apparatus of claim 10, wherein the apparatus further comprises a portable third heater for heating the surface of the object, the third heater being pivotally connected to the second heater by a connecting hinge.

12. The apparatus of claim 11, wherein the third heater is selected from the group consisting of an infrared heater and a convection heater.

13. The apparatus of claim 12, wherein the connecting hinge is positioned above the inside wall of the bathtub, and the second heater and the third heater are pivoted about the connecting hinge to direct the second heater and the third heater towards two different areas of the inside wall of the bathtub.

14. The apparatus of claim 12, the apparatus further comprising a portable shielding member for shielding an area surrounding the bathtub from the heat emitted from the first heater, the second heater, and the third heater.

15. The apparatus of claim 12, wherein the second heater and the third heater are movable in a horizontal direction.

16. The apparatus of claim 15, the apparatus further comprising a portable inner bar section having a first end extending in the horizontal direction and a second end extending downwardly in the vertical direction, the inner bar section being mounted at the second end to the vertical support member,
wherein the horizontal support member comprises a first outer bar section which extends in the horizontal direction and which is telescopically and slidably connected over the first end of the inner bar section, the first outer bar section having a larger diameter than the inner bar section, and
wherein the second heater and the third heater are movable in the horizontal direction by sliding the first outer bar section relative to the inner bar section.

17. The apparatus of claim 16, wherein the second heater and the third heater are movable in the vertical direction.

18. The apparatus of claim 17, wherein the vertical support member comprises a second outer bar section which extends upwardly in the vertical direction and which is telescopically and slidably connected over the second end of the inner bar section, the second outer bar section having a larger diameter than the inner bar section, and
wherein the second heater and the third heater are movable in the vertical direction by sliding the inner bar section relative to the second outer bar section.

19. A method of powder coating a bathtub comprising the steps of:
applying a powder comprising a thermal plastic polymer or a thermoset polymer to a surface of the bathtub,
heating the surface of the bathtub with a portable heating apparatus, and
allowing the thermoplastic polymer or thermoset polymer powder to cure.

20. The method of claim 19, wherein the portable heating apparatus is the apparatus as defined in claim 1.
